(19) United States
(12) Patent Application Publication
(10) Pub. No.: US 2012/0163720 A1
(43) Pub. Date: Jun. 28, 2012

(54) IMAGE PROCESSING APPARATUS AND METHOD THEREOF

(75) Inventors: Kanako Saito, Tokyo (JP); Toshimitsu Kaneko, Kanagawa (JP); Takashi Ida, Kanagawa (JP)

(73) Assignee: Kabushiki Kaisha Toshiba, Minato-ku, Tokyo (JP)

(21) Appl. No.: 13/394,283

(22) PCT Filed: Sep. 4, 2009
(86) PCT No.: PCT/JP2009/004376

§ 371 Date: Mar. 5, 2012

(51) Int. Cl. G06T 3/40; G06K 9/46

(52) U.S. Cl. 382/195

(57) ABSTRACT

A specifying unit specifies a pixel value at a pixel position of a reference image to a pixel of a sample enlarged image at a position relative to a pixel position of the reference image as an initial pixel value. A selecting unit selects a target pixel from pixels other than pixels having the pixel values specified therefor including the pixels having the initial pixel values are set in the sample enlarged image. An allocating unit configured to allocate the pixel value of the pixel at a similar region position of the reference image to the pixel value of the target value in the sample enlarged image when a searching unit searches the similar region position similar to a pixel value pattern including a set of already specified pixels in a spatial neighborhood of the target pixel from the reference image is provided.

### TECHNICAL FIELD

The present invention relates to an image processing technology for enlarging an image.

### BACKGROUND ART

Non-Patent Document 1 discloses a method of generating an enlarged image when generating the enlarged image by enlarging an original image (hereinafter, referred to as a “reference image”), which is capable of giving a sense that a texture (pattern) in the reference image is naturally continued. In this method, a value from 0 to 255 is randomly allocated to an initial pixel value of the enlarged image, and then, new pixel values are allocated in sequence from an upper left pixel. In a near field region of a target pixel to be allocated with a pixel value, a region having a pixel value pattern most similar to that of the pixels which are already allocated with the pixel values is searched from the reference image. The pixel value of a searched corresponding pixel is allocated as the pixel value of the target pixel.
Non-Patent Document 1: Li-Yi Wei, Marc Levoy. “Fast Texture Synthesis using Tree-structured Vector Quantization,” Proc. SIGGRAPH 2000, pp. 479-488, 2000.

### DISCLOSURE OF THE INVENTION

### Problems to be Solved by the Invention

However, in the method disclosed in Non-Patent Document 1, there is a problem in that if it is applied to a reference image having plural types of textures or edges, a picture composition of patterns and edges cannot be maintained.

In order to solve the problem described above, it is an object of the present invention to provide an image processing apparatus which is capable of generating an enlarged image from a reference image while maintaining a texture and a picture composition such as a range, position, or arrangement of the edges, and a method thereof.

### Means for Solving the Problems

The present invention provides an image processing apparatus including:

a specifying unit configured to specify a pixel value at a pixel position of a reference image located at a position relative to a pixel position of the reference image for plural initial pixels of a sample enlarged image enlarged from the reference image at an arbitrary scale of enlargement;

a selecting unit configured to select one or plural target pixels from among pixels of the sample enlarged image having no pixel value allocated thereto and the initial pixel whose pixel value specified by the specifying unit is not yet renewed;

a searching unit configured to search a similar region position of a pixel value pattern similar to a pixel value pattern of a region including a set of pixels having pixel values allocated thereto in a spatial neighborhood of the target pixel from the reference image; and

an allocating unit configured to allocate a pixel value of a pixel at the similar region position of the reference image to the pixel value of the target pixel of the sample enlarged image.

### Advantages of the Invention

According to the present invention, an enlarged image in which a texture and a picture composition such as a range, position, or arrangement of edges are maintained can be generated from a reference image.

### BRIEF DESCRIPTION OF THE DRAWINGS

FIG. 1 is a block diagram showing an image processing apparatus according to Embodiment 1.

FIG. 2 is a flowchart showing operations of the image processing apparatus according to Embodiment 1.

FIG. 3 is an explanatory drawing showing a method of selecting a template region.

FIG. 4 is a block diagram showing an image processing apparatus according to Embodiment 2.

FIG. 5 is a flowchart showing operations of the image processing apparatus according to Embodiment 2.

FIG. 6 is a block diagram showing an image processing apparatus according to Embodiment 5.

FIG. 7 is a flowchart showing operations of the image processing apparatus according to Embodiment 5.

### BEST MODES FOR CARRYING OUT THE INVENTION

Referring now to the drawings, an image processing apparatus according to an embodiment of the present invention will be described. In the respective embodiments, the same components are designated by common reference numerals, and overlapped description is omitted. The image processing apparatus in this embodiment is mounted on image display apparatuses such as TVs, video cameras, and so on.

### Embodiment 1

An image processing apparatus 1 in this embodiment enlarges a reference image 105, and generates an enlarged image 110 in which a texture and a picture composition such as a range, position, or arrangement of edges in the reference image are maintained.

### (1) Configuration of Image Processing Apparatus

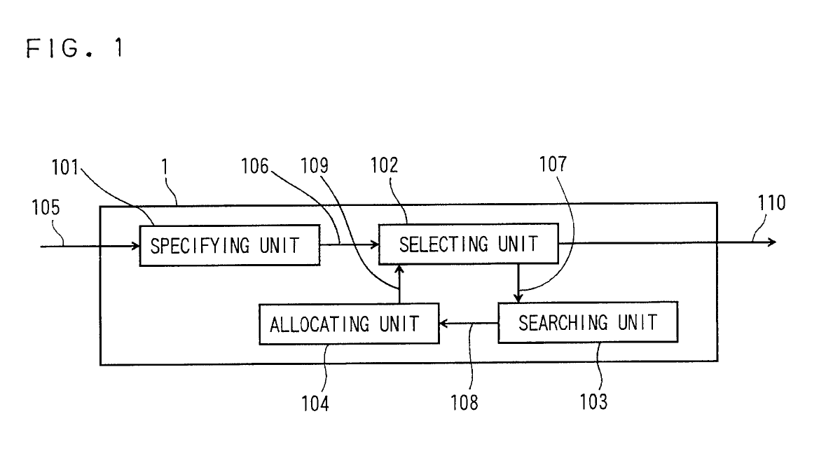

FIG. 1 is a block diagram showing the image processing apparatus 1.

The image processing apparatus 1 includes a specifying unit 101, a selecting unit 102, a searching unit 103, and an allocating unit 104.

For example, when the reference image 105 as a grayscale image is entered, the specifying unit 101 enlarges the reference image 105 by an arbitrary scale of enlargement k and generates a sample enlarged image. The sample enlarged image has pixels having the same size as the reference image 105 and has an increased number of pixels on the basis of the scale of enlargement k. Each pixel of the sample enlarged image does not have a pixel value specified therefor, and is still in balance. The scale of enlargement is determined by the enlarged image 110 which is finally wanted to be produced. Then, the pixel value of the reference image 105 is specified as, that is, allocated to the pixel values of part of pixels of the generated sample enlarged image (hereinafter, referred to as “initial pixels”) as initial pixels. Pixel positions of the sample enlarged image to be specified are assumed to be pixels at positions relatively corresponding to a pixel position of the reference image 105. The term “pixel value” here is, for example, an intensity value.

The selecting unit 102 selects a pixel to be allocated with a pixel value (hereinafter, referred to as “target pixel”) from pixels in the sample enlarged image other than the initial pixels.

The searching unit 103 searches spatial neighborhoods of the target pixel selected by the selecting unit 102 and a region having a similar pixel value pattern (hereinafter, referred to as “similar region position”) from the reference image 105.

The allocating unit 104 allocates the pixel values of pixels at the similar region position of the reference image 105 searched by the searching unit 103 as the pixel value of the target pixel of the sample enlarged image.

### (2) Operation of the Image Processing Apparatus 1

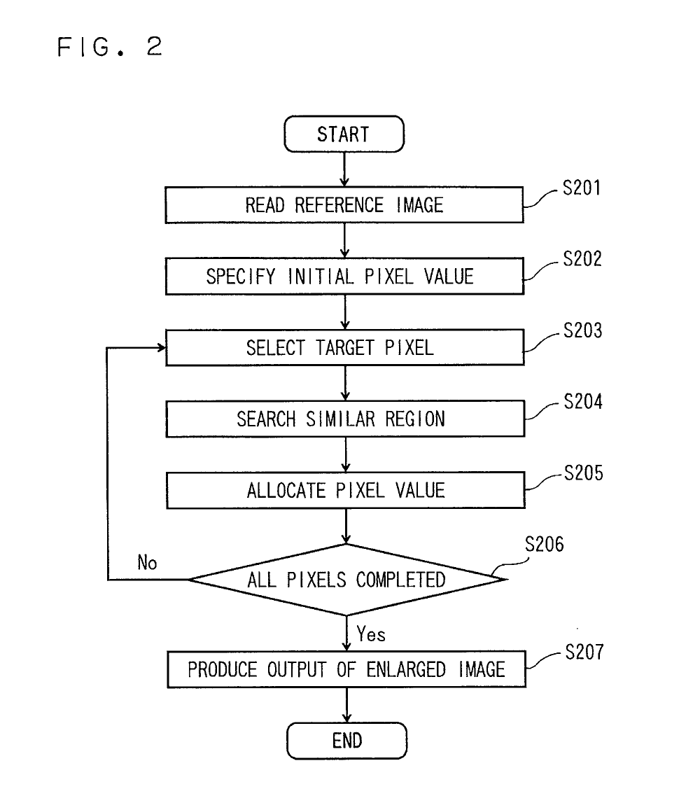

FIG. 2 is a flowchart showing an operation of the image processing apparatus 1.

In Step S201, the specifying unit 101 reads the reference image 105, and generates a sample enlarged image from the reference image 105 on the basis of the scale of enlargement k, and the procedure goes to Step S202. The reference image 105 is an image including one or more types of texture. The reference image 105 may include an edge.

In Step S202, the specifying unit 101 specifies the pixel value of the reference image 105 for the initial pixels, which are part of pixels of the sample enlarged image, as initial pixel values, and the procedure goes to Step S203. The sample enlarged image having the initial pixels specified with the initial pixel values in Step S202 is referred to as an “initial enlarged image 106”. The initial pixels in the initial enlarged image 106 are arranged in at least one row and one column at regular intervals. If the interval is too large, continuity of the edges can hardly be maintained. Therefore, the interval is preferably on the order of one-row and one-column, or two-rows and two-columns. When the ratio of the horizontal size between the reference image 105 and the initial enlarged image 106 is 1: kx and the ratio of the vertical size therebetween is 1:ky (provided that k is the scale of enlargement), the initial pixel value specified for the initial pixel (x, y) of the initial enlarged image 106 is the pixel value of the pixel (x/kx, y/ky) of the reference image 105. In other words, the initial pixel value is specified for the initial pixels at the pixel positions (pixel coordinate value) of the sample enlarged image relatively corresponding to the pixel position (pixel coordinate value) of the reference image 105.

In Step S203, the selecting unit 102 selects a target pixel coordinate 107, which is a coordinate value of the target pixel from the pixels of the sample enlarged image, and the procedure goes to Step S204. One target pixel is selected from the pixels of the initial enlarged image 106 other than the initial pixels. The order of the selection is arbitrary.

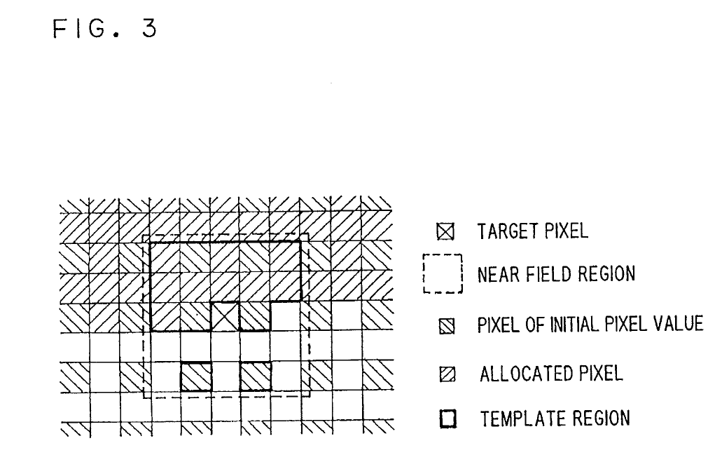

In Step S204, the searching unit 103 specifies a spatial neighborhood of the target pixel coordinate 107 as a template region, searches a region similar to the pixel value pattern in the template region from the reference image 105, and specifies the result of search as a similar region position 108, and the procedure goes to Step S205. As shown in FIG. 3, the template region (the size is, for example, 5×5 [pixel]) is within a rectangular near field region having a size of N×N [pixel] (the size is, for example, 5×5 [pixel]) having the target pixel coordinate 107 at the center, and is a set of pixels having the pixel value already specified therefor.

Here, in the initial enlarged image 106 in the first process, the term “the pixels having the pixel values specified therefor” means only the initial pixels having the initial pixel values specified therefor and, in the sample enlarged image from the second process onward (a renewed enlarged image described later), it means both the initial pixels specified (allocated) by the specifying unit 101 and allocated pixels having the pixel values allocated by the allocating unit 104. FIG. 3 shows a template region in a case where the initial pixel values are allocated to initial pixels line-by-line and column-by-column, and the target pixel coordinate 107 is selected from an upper left pixel to a lower right pixel of the image in sequence. In all the pixels of the reference image 105, differences in pixel values between the spatial neighborhood thereof and within the template region are calculated, and a pixel having a minimum difference is selected. The center pixel of the selected region corresponds to the similar region position 108 described above. When calculating the differences between the pixel values in the two regions, SSD (Sum of Squared Difference) may be calculated on the pixel-by-pixel basis, or SAD (Sum of Absolute Difference) may be calculated on the pixel-by-pixel basis.

In Step S205, the allocating unit 104 allocates the pixel value of the pixel at the similar region position 108 of the reference image 105 to the pixel value of the target pixel coordinate 107 of the sample enlarged image, and the procedure goes to Step S206. The enlarged image in a state in which the pixel values are not allocated to all the pixels of the sample enlarged image is referred to as a “renewed enlarged image 109”.

In Step S206, the selecting unit 102 determines whether or not all the pixel values of the renewed enlarged image 109 are allocated and, if not, the procedure goes back to Step S203 (the case of No in FIG. 2). When the allocation of the pixel values of all the pixels is completed, the procedure goes to Step S207 (the case of Yes in FIG. 2).

In Step S207, the selecting unit 102 produces an output of the renewed enlarged image 109 having all the pixels allocated with the pixel values as the enlarged image 110.

### (3) Advantages

According to this embodiment, by specifying the pixel value of the reference image for the initial pixel values of the initial pixels of the sample enlarged image, selection of the similar region position from a different texture region when searching the similar region position can be prevented. Accordingly, even for the reference image having plural textures and edges mixed therein, the enlarged image enlarged while maintaining the texture and the picture composition such as the range, position, or arrangement of the edges in the reference image can be generated.

### Embodiment 2

This embodiment is different from the image processing apparatus in Embodiment 1 in that the specifying unit 101 uses the pixel values of the image enlarged from the reference image instead of the pixel value of the pixel of the reference image for the initial enlarged image.

### (1) Configuration of Image Processing Apparatus 4

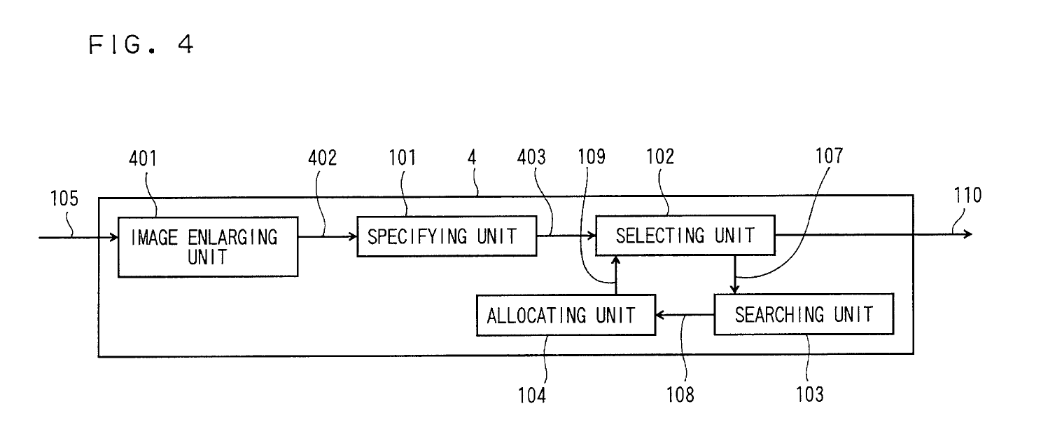

FIG. 4 is a block diagram showing the image processing apparatus 1.

The image processing apparatus 4 in this embodiment includes an image enlarging unit 401 added to the specifying unit 101, the selecting unit 102, the searching unit 103, and the allocating unit 104.

### (2) Operation of the Image Processing Apparatus 4

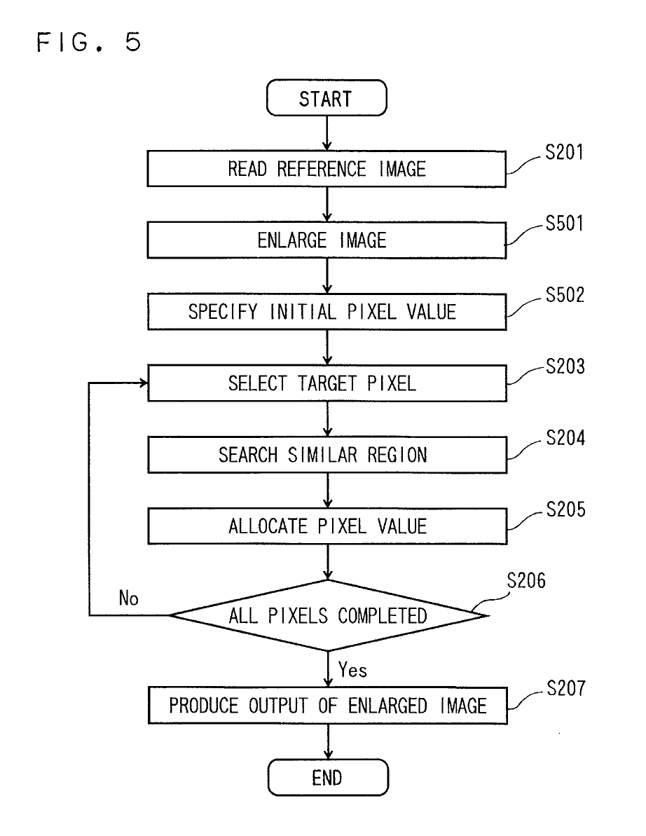

Referring now to FIG. 5, an operation of the image processing apparatus 4 will be described. FIG. 5 is a flowchart showing the operation of the image processing apparatus 4.

In Step S501, the reference image 105 is entered to the image enlarging unit 401.

The image enlarging unit 401 enlarges the reference image 105 at the scale of enlargement k to the same size as the sample enlarged image, and the procedure goes to Step S502. The reference image 105 after the enlargement is referred to as a “reference enlarged image 402”. As an image enlargement method, an arbitrary image enlargement method other than that in the present invention may be used. For example, methods of enlarging an image by interpolating pixel values such as a nearest neighbor interpolation (nearest neighbor method), a linear interpolation, or a cubic convolution method may be employed. However, it is preferable to use a method which can generate an image with a least blur.

In Step S502, the specifying unit 101 specifies the pixel value of pixel of the reference enlarged image 402 for the initial pixels of the sample enlarged image, as initial pixel values, and the procedure goes to Step S203. The sample enlarged image having the initial pixel values specified for the initial pixels in Step S502 is referred to as an “initial enlarged image 403” as in Embodiment 1. The initial pixels in the initial enlarged image 403 are arranged in at least one row and one column at regular intervals. If the interval is too large, continuity of the edges can hardly be maintained. Therefore, the interval is preferably on the order of one-row and one-column, or two-rows and two-columns. Then, the specifying unit 101 specifies the initial pixel value of the initial pixel (x, y) of the initial enlarged image 403 as the pixel value of the pixel (x, y) of the reference enlarged image 402. In other words, the pixel values of the pixels of the sample enlarged image and the reference enlarged image at the relatively same positions are specified as the initial pixel values.

In Steps S203 to S207, the respective units 102 to 104 of the image processing apparatus 4 perform the same operation as in Embodiment 1 to generate the enlarged image 110.

### (3) Advantages

According to this embodiment, one-to-one correspondence of the pixels is achieved between the reference enlarged image which is an original of the initial pixel value to be specified and the sample enlarged image as a destination to be specified.

### Embodiment 3

The image processing apparatus in this embodiment is different from Embodiment 1 in that the specifying unit 101 selects the initial pixels in the sample enlarged image at random instead of at regular intervals in Step S202.

The number of pixels of the initial pixels to be selected when the specifying unit 101 selects from the sample enlarged image at random is preferably about one-fourth of the total number of pixels of the sample enlarged image. Also, in Step S204, when the searching unit 103 searches the similar region position, the template region is prepared in the near field region of a size N×N [pixel] (for example, 5×5 [pixel]). Therefore, at least one initial pixel is needed to be specified within the regions of N×N [pixel] centered at the respective pixels.

According to this embodiment, the pixel values of the initial pixels are kept a low profile in the output of the enlarged image 110, and hence an enlarged image can be generated with high degree of accuracy.

### Embodiment 4

The image processing apparatus in this embodiment is different from Embodiment 1 in that the selecting unit 102 selects a set of plural adjacent pixels instead of selecting one sole pixel when selecting the target pixel from the sample enlarged image in Step S203.

The number of pixels to be selected by the selecting unit 102 is preferably on the order of 2 pixels or 3 pixels. When the selecting unit 102 selects plural pixels in Step S203, the number of pixels to be selected for the similar region positions 108 by the searching unit 103 in Step S204 become plural correspondingly, and hence the pixel values are allocated to plural pixels in one process also when the allocating unit 104 allocates the pixel values in Step S205.

According to this embodiment, since the allocation of plural pixel values is enabled in one process, speed-up of the process is achieved.

### Embodiment 5

This embodiment is different from Embodiment 1 in that a reduced image obtained by reducing a texture component image extracted from an input image 603 is used as the reference image 105 to be supplied to the image processing apparatus 1.

### (1) Configuration of Image Processing Apparatus 6

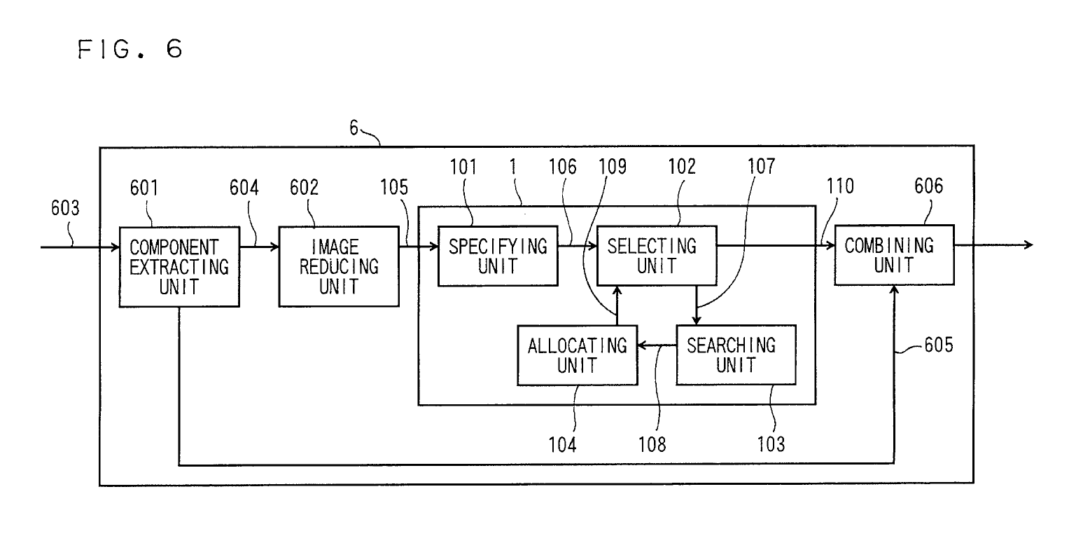

FIG. 6 is a block diagram showing a configuration of an image processing apparatus 6.

The image processing apparatus 6 includes an component extracting unit 601, an image reducing unit 602, and a combining unit 606 added to the specifying unit 101, the selecting unit 102, the searching unit 103, and the allocating unit 104.

### (2) Operation of the Image Processing Apparatus 6

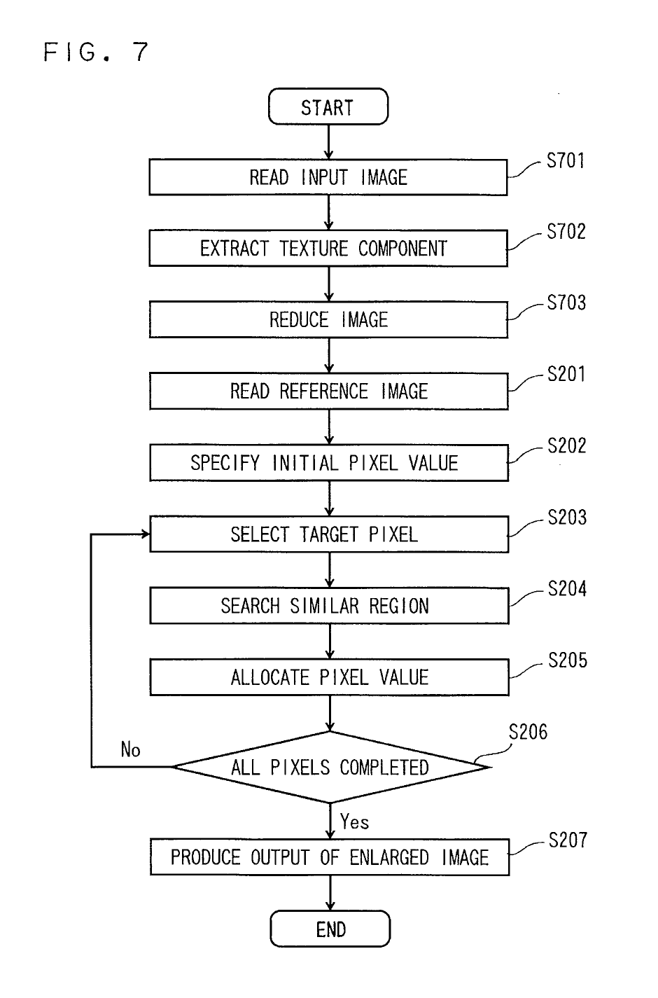

Subsequently, referring now to FIG. 7, an operation of the image processing apparatus 6 will be described. FIG. 7 is a flowchart showing the operation of the image processing apparatus 6.

In Step S701, the image processing apparatus 6 reads in a grayscale input image 603, and the procedure goes to Step S702.

In Step S702, the component extracting unit 601 extracts a texture component image 604 having only a texture component from the received grayscale input image 603 and a component image 605 other than that, and the procedure goes to Step S703. As means for extracting the texture component, for example, a structure/texture decomposition method, a Center/Surround Retinex method, or a c-filter method may be used.

In Step S703, the image reducing unit 602 reduces the received texture component image 604 to produce the reduced image, and produces an output of the reduced image as the reference image 105, then the procedure goes to Step S201. The scale of reduction can be selected arbitrarily. For example, the fineness of the texture wanted in the reduced image and the fineness of the texture in the texture component image 604 are compared, and the scale of reduction is selected to achieve the wanted fineness of the texture. In order to prevent aliasing of the reduced image from generating, it is preferable to apply a low-pass filter as a preprocessing.

In Step S201 to S207, the respective units 101 to 104 of the image processing apparatus 6 perform the same operations as in Embodiment 1.

In Step S208, the combining unit 606 combines the component image 605 made up of components other than the texture component with the enlarged image 110 generated in Step S207, and produces an output of a combined image.

### (3) Advantages

According to this embodiment, pattern of change of the texture component in the input image can be fined down, so that improvement of the quality of the input image is achieved.

### Embodiment 6

The image processing apparatus according to Embodiment 6 of the present invention will be described.

This embodiment is different from Embodiment 1 in that an enlarged image after having completed the allocation of the pixel values for all the pixels is defined as an initial enlarged image, and the processes from Step S203 onward in Embodiment 1 are performed again.

In other words, in this embodiment, the enlarged image 110 generated in the image processing apparatus 1 in Embodiment 1 is processed once more again. Detailed description will be given below.

The image processing apparatus generates an enlarged image 110 in the first process. This process is the same as that in Embodiment 1.

Subsequently, the image processing apparatus performs the second process using the enlarged image 110. The second process is performed as follows. The selecting unit 102 selects the initial pixel in the enlarged image 110 generated in the first process again as a target pixel. In other words, in this selection, a pixel specified with a pixel value of the initial pixel in the first process and then is not renewed in pixel value of the initial pixel from then onward is selected as the target pixel. The searching unit 103 searches the similar region position for this target image using the pixels to which the pixel values are already allocated in the first process. The allocating unit 104 allocates the pixel value of the pixel at the similar region position of the searched reference image 105 again to the initial pixel specified with the initial pixel value of the enlarged image 110.

According to this embodiment, allocation of the pixel values of all the pixels of the enlarged image 110 is enabled by the process of searching the similar region position, so that the enlarged image can be generated with high degree of accuracy.

The invention is not limited to the embodiments shown above as is, and components may be modified and embodied without departing from the scope of the invention in the stage of implementation. Various modes of the invention are achieved by combining the plural components disclosed in the embodiments described above as needed. For example, several components may be eliminated from all the components shown in the embodiment. In addition, the components in different embodiments may be combined as needed.

### REFERENCE NUMERALS

image processing apparatus
101 specifying unit
102 selecting unit
103 searching unit
104 allocating unit

1. An image processing apparatus comprising:
a specifying unit configured to specify a pixel value at a pixel position of a reference image located at a position relative to a pixel position of the reference image for a plurality of initial pixels of a sample enlarged image enlarged from the reference image at an arbitrary scale of enlargement;
a selecting unit configured to select one or a plurality of target pixels from among pixels of the sample enlarged image having no pixel value allocated thereto and the initial pixel whose pixel value specified by the specifying unit is not yet renewed;
a searching unit configured to search a similar region position of a pixel value pattern similar to a pixel value pattern of a region including a set of pixels having pixel values allocated thereto in a spatial neighborhood of the target pixel from the reference image; and
an allocating unit configured to allocate a pixel value of a pixel at the similar region position of the reference image to the pixel value of the target pixel of the sample enlarged image.

2. The apparatus according to claim 1, further comprising an enlarging unit configured to generate a reference enlarged image having the same size as the sample enlarged image from the reference image, wherein
the specifying unit specifies the pixel value at the pixel position of the reference enlarged image to the pixel of the sample enlarged image at a position relative to the pixel position of the reference enlarged image instead of the reference image.

3. The apparatus according to claim 2, wherein the specifying unit specifies the initial pixels in at least one row and one column at regular intervals within the sample enlarged image.

4. The apparatus according to claim 3, wherein the specifying unit specifies the initial pixels to positions in the sample enlarged image at random.

5. The apparatus according to claim 1, wherein the specifying unit uses a reduced image reduced from an image obtained by separating a texture component from an input image as the reference image.

6. An image processing method comprising:
a specifying step for specifying a pixel value at a pixel position of a reference image located at a position relative to a pixel position of the reference image for a plurality of initial pixels of the sample enlarged image enlarged from the reference image at an arbitrary scale of enlargement;
a selecting step for selecting one or a plurality of target pixels from among pixels of the sample enlarged image having no pixel value allocated thereto and the initial pixel whose pixel value specified in the specifying step is not yet renewed;
a searching step for searching a similar region position of a pixel value pattern similar to a pixel value pattern of a region including a set of pixels having pixel values allocated thereto in a spatial neighborhood of the target pixel from the reference image; and
an allocating step for allocating a pixel value of a pixel at the similar region position of the reference image to the pixel value of the target pixel of the sample enlarged image.
